(19) United States
(12) Patent Application Publication
(10) Pub. No.: US 2025/0358138 A1
(43) Pub. Date: Nov. 20, 2025

(54) METHODS AND SYSTEMS FOR CURATION OF CONTENT ITEMS OF A USER GROUP IN A CLOUD-BASED COLLABORATION ENVIRONMENT

(71) Applicant: Box, Inc., Redwood City, CA (US)

(72) Inventors: Benjamin Kus, Alameda, CA (US); Tamar Bercovici, Redwood City, CA (US); Ryan Churchill, San Francisco, CA (US); John Piscia, Redwood City, CA (US); John Huffaker, San Francisco, CA (US); Kevin Day, Shelburne Falls, MA (US); Chandra Cherukuri, San Mateo, CA (US); Jay Burke Culligan, San Carlos, CA (US)

(21) Appl. No.: 18/664,149

(22) Filed: May 14, 2024

(51) Int. Cl. H04L 12/18; G06F 16/9535

(52) U.S. Cl. CPC H04L 12/18; G06F 16/9535

(57) ABSTRACT

Embodiments of the disclosure provide systems and methods for curating access-only content items of user groups in a cloud-based collaboration environment by creating a content hub in the cloud-based collaboration environment. The content hub can comprise a logical representation of a collection of content items stored in a repository. The content hub can be populated with hub information defining the content hub and selected content items of the content items stored in the repository can be added to the content hub. The content hub can then be published in the cloud-based collaboration environment with the selected content items added to the content hub being available for access only to one or more users.

### FIELD OF THE DISCLOSURE

Embodiments of the present disclosure relate generally to methods and systems for managing content in a cloud-based collaboration environment and more particularly to curating access-only content items of user groups in a cloud-based collaboration environment.

### BACKGROUND

A cloud-based collaboration environment maintains a store of information shared between users and makes that information available to those users online through a virtual workspace. In this workspace, users can create, view, and edit the files, folders, and other information, also referred to as work items, in the store. Another type of work item that has come into use are content-related objects. These are items that can be stored in the cloud-based collaboration environment and are themselves a form of content that is related to other content. Currently, these are stored in an ad-hoc way, with each application managing its own content-related objects. Each implementation uses its own versions of things like content grouping, metadata, relationship to other objects, permissions, sharing and collaboration, compliance requirements, etc. This introduces several challenges to ensuring consistent behavior and user experience. Hence, there is a need for improved methods and systems for managing content in a cloud-based collaboration environment.

### BRIEF SUMMARY

Embodiments of the disclosure provide systems and methods for curating access-only content items of user groups in a cloud-based collaboration environment. Generally speaking, embodiments of the present disclosure are directed to the creation and use of Content Application Objects (CAOs). CAOs can be defined as content items that describe and reference other content items. According to one embodiment, a method for curating access-only content items of user groups in a cloud-based collaboration environment can comprise creating a content hub in the cloud-based collaboration environment, the content hub comprising a logical representation of a collection of content items stored in a repository maintained by a collaboration server. Creating the content hub in the cloud-based collaboration environment can comprise creating a Content Application Object (CAO) for the content hub and associating the created CAO with the content hub.

The content hub can then be populated with hub information defining the content hub. Populating the content hub can comprise adding the hub information to the CAO, the hub information comprising one or more of a name for the content hub, a description of the content hub, or one or more sections within the content hub.

One or more selected content items of the content items stored in the repository maintained by the collaboration server can then be added to the content hub. Adding one or more content items to the content hub can comprise confirming each editor of the added one or more content items has access to the one or more content items within the content hub and adding an Access Only Collaboration (AOC) to the added one or more content items.

The content hub can then be published in the cloud-based collaboration environment, wherein the selected content items added to the content hub are available for access only to one or more users of the collaboration server. Publishing the content hub in the cloud-based collaboration environment can comprise adding an association of each of the added one or more content items to the CAO, adding an AOC collaboration for each of one or more viewers of the added one or more content items, and adding searchable text to the CAO, the searchable text describing the content hub or content items added to the content hub.

In some cases, the content hub can be updated. Updating the content hub can comprise one or more of changing the hub information for the content hub adding one or more content items to the content hub or removing one or more content items from the content hub. Changing the hub information for the content hub can comprise saving the changed hub information for the content hub. Adding one or more content items to the content hub can comprise confirming editors for the added one or more content items have access to the added content items within the content hub and adding an Access Only Collaboration (AOC) to the added content items.

The content hub can then be published with the changed hub information, without the removed one or more content items or with the added one or more content items. Publishing the content hub can comprise adding content item associations on the CAO associated with the content hub for any added content items, removing content item associations on the CAO associated with the content hub for any removed content items, updating searchable text for the content hub and updating a status for the content hub.

According to another embodiment, a system can comprise a processor and a memory coupled with and readable by the processor. The memory can store therein a set of instructions which, when executed by the processor, causes the processor to curate access-only content items of user groups in a cloud-based collaboration environment by creating a content hub in the cloud-based collaboration environment, the content hub comprising a logical representation of a collection of content items stored in a repository maintained by the collaboration server. Creating the content hub in the cloud-based collaboration environment can comprise creating a Content Application Object (CAO) for the content hub and associating the created CAO with the content hub.

The instructions can further cause the processor to populate the content hub with hub information defining the content hub. Populating the content hub can comprise adding the hub information to the CAO, the hub information comprising one or more of a name for the content hub, a description of the content hub, or one or more sections within the content hub.

The instructions can further cause the processor to add one or more selected content items of the content items stored in the repository maintained by the collaboration server to the content hub. Adding one or more content items to the content hub can comprise confirming each editor of the added one or more content items has access to the one or more content items within the content hub and adding an Access Only Collaboration (AOC) to the added one or more content items.

The instructions can further cause the processor to publish the content hub in the cloud-based collaboration environment, wherein the selected content items added to the content hub are available for access only to one or more users of the collaboration server. Publishing the content hub in the cloud-based collaboration environment can comprise adding an association of each of the added one or more content items to the CAO, adding an AOC collaboration for each of one or more viewers of the added one or more content items and adding searchable text to the CAO, the searchable text describing the content hub or content items added to the content hub.

The instructions further cause the processor to update the content hub. Updating the content hub can comprise one or more of changing the hub information for the content hub adding one or more content items to the content hub or removing one or more content items from the content hub. Changing the hub information for the content hub can comprise saving the changed hub information for the content hub. Adding one or more content items to the content hub can comprise confirming editors for the added one or more content items have access to the added content items within the content hub and adding an Access Only Collaboration (AOC) to the added content items.

The instructions can further cause the processor to publish the content hub with the changed hub information, without the removed one or more content items or with the added one or more content items. Publishing the content hub can comprise adding content item associations on the CAO associated with the content hub for any added content items, removing content item associations on the CAO associated with the content hub for any removed content items, updating searchable text for the content hub, and updating a status for the content hub.

According to yet another embodiment, a non-transitory, computer-readable medium can comprise a set of instructions stored therein which, when executed by a processor, causes the processor to curate access-only content items of user groups in a cloud-based collaboration environment by creating a content hub in the cloud-based collaboration environment, the content hub comprising a logical representation of a collection of content items stored in a repository maintained by the collaboration server. Creating the content hub in the cloud-based collaboration environment can comprise creating a Content Application Object (CAO) for the content hub and associating the created CAO with the content hub.

The instructions can further cause the processor to populate the content hub with hub information defining the content hub. Populating the content hub can comprise adding the hub information to the CAO, the hub information comprising one or more of a name for the content hub, a description of the content hub, or one or more sections within the content hub.

The instructions can further cause the processor to add one or more selected content items of the content items stored in the repository maintained by the collaboration server to the content hub. Adding one or more content items to the content hub can comprise confirming each editor of the added one or more content items has access to the one or more content items within the content hub and adding an Access Only Collaboration (AOC) to the added one or more content items.

The instructions can further cause the processor to publish the content hub in the cloud-based collaboration environment, wherein the selected content items added to the content hub are available for access only to one or more users of the collaboration server. Publishing the content hub in the cloud-based collaboration environment can comprise adding an association of each of the added one or more content items to the CAO, adding an AOC collaboration for each of one or more viewers of the added one or more content items and adding searchable text to the CAO, the searchable text describing the content hub or content items added to the content hub.

The instructions further cause the processor to update the content hub. Updating the content hub can comprise one or more of changing the hub information for the content hub adding one or more content items to the content hub, or removing one or more content items from the content hub. Changing the hub information for the content hub can comprise saving the changed hub information for the content hub. Adding one or more content items to the content hub can comprise confirming editors for the added one or more content items have access to the added content items within the content hub and adding an Access Only Collaboration (AOC) to the added content items.

The instructions can further cause the processor to publish the content hub with the changed hub information, without the removed one or more content items or with the added one or more content items. Publishing the content hub can comprise adding content item associations on the CAO associated with the content hub for any added content items, removing content item associations on the CAO associated with the content hub for any removed content items, updating searchable text for the content hub, and updating a status for the content hub.

### BRIEF DESCRIPTION OF THE DRAWINGS

FIG. 1 is a block diagram illustrating elements of an exemplary computing environment in which embodiments of the present disclosure may be implemented.

FIG. 2 is a block diagram illustrating elements of an exemplary computing device in which embodiments of the present disclosure may be implemented.

FIG. 3 is a block diagram illustrating an exemplary cloud-based collaboration environment in which embodiments of the present disclosure may be implemented.

FIG. 4 is a screenshot illustrating an exemplary user interface for a cloud-based collaboration environment according to one embodiment of the present disclosure.

FIG. 5 is a block diagram conceptually illustrating sharing of content items in a cloud-based collaboration environment according to one embodiment of the present disclosure.

FIG. 6 is a block diagram illustrating additional details of a cloud-based collaboration system architecture according to one embodiment of the present disclosure.

FIG. 7 is a flowchart illustrating an exemplary process for curating access-only content items of user groups in a cloud-based collaboration environment according to one embodiment of the present disclosure.

FIG. 8 is a flowchart illustrating an exemplary process for curating access-only content items of user groups in a cloud-based collaboration environment according to another embodiment of the present disclosure.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION

In the following description, for the purposes of explanation, numerous specific details are set forth in order to provide a thorough understanding of various embodiments disclosed herein. It will be apparent, however, to one skilled in the art that various embodiments of the present disclosure may be practiced without some of these specific details. The ensuing description provides exemplary embodiments only and is not intended to limit the scope or applicability of the disclosure. Furthermore, to avoid unnecessarily obscuring the present disclosure, the preceding description omits a number of known structures and devices. This omission is not to be construed as a limitation of the scopes of the claims. Rather, the ensuing description of the exemplary embodiments will provide those skilled in the art with an enabling description for implementing an exemplary embodiment. It should however be appreciated that the present disclosure may be practiced in a variety of ways beyond the specific detail set forth herein.

While the exemplary aspects, embodiments, and/or configurations illustrated herein show the various components of the system collocated, certain components of the system can be located remotely, at distant portions of a distributed network, such as a Local-Area Network (LAN) and/or Wide-Area Network (WAN) such as the Internet, or within a dedicated system. Thus, it should be appreciated, that the components of the system can be combined in to one or more devices or collocated on a particular node of a distributed network, such as an analog and/or digital telecommunications network, a packet-switch network, or a circuit-switched network. It will be appreciated from the following description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

As used herein, the phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium” as used herein refers to any tangible storage and/or transmission medium that participate in providing instructions to a processor for execution. Such a medium may take many forms, including but not limited to, non-volatile media, volatile media, and transmission media. Non-volatile media includes, for example, Non-Volatile Random-Access Memory (NVRAM), or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a Compact Disk Read-Only Memory (CD-ROM), any other optical medium, punch cards, paper tape, any other physical medium with patterns of holes, a Random-Access Memory (RAM), a Programmable Read-Only Memory (PROM), and

Erasable Programable Read-Only Memory (EPROM), a Flash-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored.

A “computer readable signal” medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, Radio Frequency (RF), etc., or any suitable combination of the foregoing.

The terms “determine,” “calculate,” and “compute,” and variations thereof, as used herein, are used interchangeably and include any type of methodology, process, mathematical operation or technique.

It shall be understood that the term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary of the disclosure, brief description of the drawings, detailed description, abstract, and claims themselves.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as Programmable Logic Device (PLD), Programmable Logic Array (PLA), Field Programmable Gate Array (FPGA), Programmable Array Logic (PAL), special purpose computer, any comparable means, or the like. In general, any device(s) or means capable of implementing the methodology illustrated herein can be used to implement the various aspects of this disclosure. Exemplary hardware that can be used for the disclosed embodiments, configurations, and aspects includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or Very Large-Scale Integration (VLSI) design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or Common Gateway Interface (CGI) script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

Various additional details of embodiments of the present disclosure will be described below with reference to the figures. While the flowcharts will be discussed and illustrated in relation to a particular sequence of events, it should be appreciated that changes, additions, and omissions to this sequence can occur without materially affecting the operation of the disclosed embodiments, configuration, and aspects.

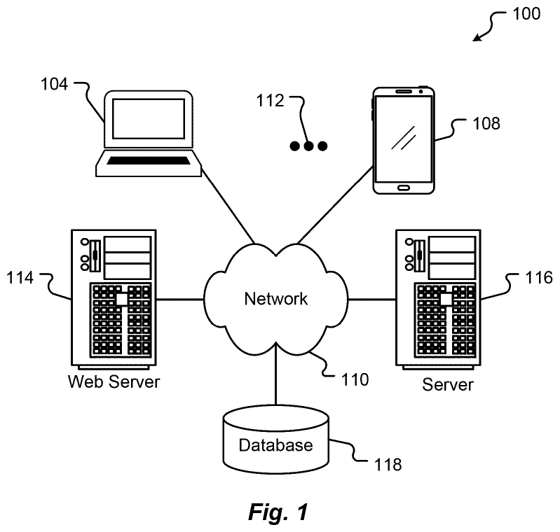

FIG. 1 is a block diagram illustrating elements of an exemplary computing environment in which embodiments of the present disclosure may be implemented. More specifically, this example illustrates a computing environment 100 that may function as the servers, user computers, or other systems provided and described herein. The environment 100 includes one or more user computers, or computing devices, such as a computing device 104, a communication device 108, and/or more 112. The computing devices 104, 108, 112 may include general purpose personal computers (including, merely by way of example, personal computers, and/or laptop computers running various versions of Microsoft Corp.'s Windows® and/or Apple Corp.'s Macintosh® operating systems) and/or workstation computers running any of a variety of commercially-available UNIX® or UNIX-like operating systems. These computing devices 104, 108, 112 may also have any of a variety of applications, including for example, database client and/or server applications, and web browser applications. Alternatively, the computing devices 104, 108, 112 may be any other electronic device, such as a thin-client computer, Internet-enabled mobile telephone, and/or personal digital assistant, capable of communicating via a network 110 and/or displaying and navigating web pages or other types of electronic documents. Although the exemplary computer environment 100 is shown with two computing devices, any number of user computers or computing devices may be supported.

Environment 100 further includes a network 110. The network 110 may can be any type of network familiar to those skilled in the art that can support data communications using any of a variety of commercially-available protocols, including without limitation Session Initiation Protocol (SIP), Transmission Control Protocol/Internet Protocol (TCP/IP), Systems Network Architecture (SNA), Internetwork Packet Exchange (IPX), AppleTalk, and the like. Merely by way of example, the network 110 maybe a Local Area Network (LAN), such as an Ethernet network, a Token-Ring network and/or the like; a wide-area network; a virtual network, including without limitation a Virtual Private Network (VPN); the Internet; an intranet; an extranet; a Public Switched Telephone Network (PSTN); an infra-red network; a wireless network (e.g., a network operating under any of the IEEE 802.9 suite of protocols, the Bluetooth® protocol known in the art, and/or any other wireless protocol); and/or any combination of these and/or other networks.

The system may also include one or more servers 114, 116. In this example, server 114 is shown as a web server and server 116 is shown as an application server. The web server 114, which may be used to process requests for web pages or other electronic documents from computing devices 104, 108, 112. The web server 114 can be running an operating system including any of those discussed above, as well as any commercially-available server operating systems. The web server 114 can also run a variety of server applications, including SIP servers, HyperText Transfer Protocol (secure) (HTTP(s)) servers, FTP servers, CGI servers, database servers, Java servers, and the like. In some instances, the web server 114 may publish operations available operations as one or more web services.

The environment 100 may also include one or more file and or/application servers 116, which can, in addition to an operating system, include one or more applications accessible by a client running on one or more of the computing devices 104, 108, 112. The server(s) 116 and/or 114 may be one or more general purpose computers capable of executing programs or scripts in response to the computing devices 104, 108, 112. As one example, the server 116, 114 may execute one or more web applications. The web application may be implemented as one or more scripts or programs written in any programming language, such as Java™, C, C#®, or C++, and/or any scripting language, such as Perl, Python, or Tool Command Language (TCL), as well as combinations of any programming/scripting languages. The application server(s) 116 may also include database servers, including without limitation those commercially available from Oracle®, Microsoft®, Sybase®, IBM® and the like, which can process requests from database clients running on a computing device 104, 108, 112.

The web pages created by the server 114 and/or 116 may be forwarded to a computing device 104, 108, 112 via a web (file) server 114, 116. Similarly, the web server 114 may be able to receive web page requests, web services invocations, and/or input data from a computing device 104, 108, 112 (e.g., a user computer, etc.) and can forward the web page requests and/or input data to the web (application) server 116. In further embodiments, the server 116 may function as a file server. Although for ease of description, FIG. 1 illustrates a separate web server 114 and file/application server 116, those skilled in the art will recognize that the functions described with respect to servers 114, 116 may be performed by a single server and/or a plurality of specialized servers, depending on implementation-specific needs and parameters. The computer systems 104, 108, 112, web (file) server 114 and/or web (application) server 116 may function as the system, devices, or components described herein.

The environment 100 may also include a database 118. The database 118 may reside in a variety of locations. By way of example, database 118 may reside on a storage medium local to (and/or resident in) one or more of the computers 104, 108, 112, 114, 116. Alternatively, it may be remote from any or all of the computers 104, 108, 112, 114, 116, and in communication (e.g., via the network 110) with one or more of these. The database 118 may reside in a Storage-Area Network (SAN) familiar to those skilled in the art. Similarly, any necessary files for performing the functions attributed to the computers 104, 108, 112, 114, 116 may be stored locally on the respective computer and/or remotely, as appropriate. The database 118 may be a relational database, such as Oracle 20i®, that is adapted to store, update, and retrieve data in response to Structured Query Language (SQL) formatted commands.

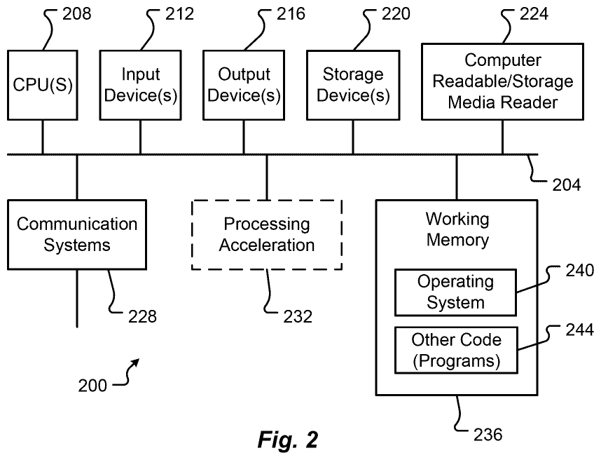

FIG. 2 is a block diagram illustrating elements of an exemplary computing device in which embodiments of the present disclosure may be implemented. More specifically, this example illustrates one embodiment of a computer system 200 upon which the servers, user computers, computing devices, or other systems or components described above may be deployed or executed. The computer system 200 is shown comprising hardware elements that may be electrically coupled via a bus 204. The hardware elements may include one or more Central Processing Units (CPUs) 208; one or more input devices 212 (e.g., a mouse, a keyboard, etc.); and one or more output devices 216 (e.g., a display device, a printer, etc.). The computer system 200 may also include one or more storage devices 220. By way of example, storage device(s) 220 may be disk drives, optical storage devices, solid-state storage devices such as a Random-Access Memory (RAM) and/or a Read-Only Memory (ROM), which can be programmable, flash-updateable and/or the like.

The computer system 200 may additionally include a computer-readable storage media reader 224; a communications system 228 (e.g., a modem, a network card (wireless or wired), an infra-red communication device, etc.); and working memory 236, which may include RAM and ROM devices as described above. The computer system 200 may also include a processing acceleration unit 232, which can include a Digital Signal Processor (DSP), a special-purpose processor, and/or the like.

The computer-readable storage media reader 224 can further be connected to a computer-readable storage medium, together (and, optionally, in combination with storage device(s) 220) comprehensively representing remote, local, fixed, and/or removable storage devices plus storage media for temporarily and/or more permanently containing computer-readable information. The communications system 228 may permit data to be exchanged with a network and/or any other computer described above with respect to the computer environments described herein. Moreover, as disclosed herein, the term “storage medium” may represent one or more devices for storing data, including ROM, RAM, magnetic RAM, core memory, magnetic disk storage mediums, optical storage mediums, flash memory devices and/or other machine-readable mediums for storing information.

The computer system 200 may also comprise software elements, shown as being currently located within a working memory 236, including an operating system 240 and/or other code 244. It should be appreciated that alternate embodiments of a computer system 200 may have numerous variations from that described above. For example, customized hardware might also be used and/or particular elements might be implemented in hardware, software (including portable software, such as applets), or both. Further, connection to other computing devices such as network input/output devices may be employed.

Examples of the processors 208 as described herein may include, but are not limited to, at least one of Qualcomm® Snapdragon® 800 and 801, Qualcomm® Snapdragon® 620 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

Any one or more servers and/or other computing devices as described above can be adapted to provide an online or cloud-based collaboration environment. As known in the art, a cloud-based collaboration environment maintains a store of information shared between users and makes that information available to those users online through a virtual workspace. In this workspace, users can create, view, and edit the files, folders, and other information, also referred to as work items, in the store. Embodiments of the disclosure provide systems and methods for curating access-only content items of user groups in a cloud-based collaboration environment. Generally speaking, embodiments of the present disclosure are directed to the creation and use of Content Application Objects (CAOs). CAOs can be defined as content items that describe and reference other content items. Embodiments enable access to and sharing of the content items through the CAOs without modifying underlying permissions on the actual content items.

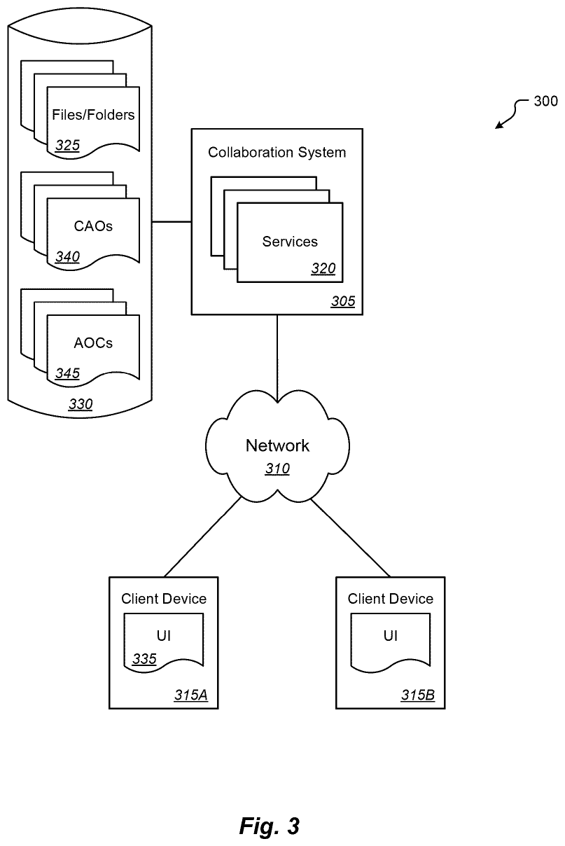

FIG. 3 is a block diagram illustrating an exemplary cloud-based collaboration environment in which embodiments of the present disclosure may be implemented. As illustrated in this example, the environment 300 can comprise a collaboration system 305 coupled with a communication network 310. As noted, the collaboration system 305 can comprise any one or more servers and/or other computing devices as described above. The communication network 310 can comprise any one or more wired and/or wireless, local-area and/or wide-area networks as described above including, but not limited to, the Internet.

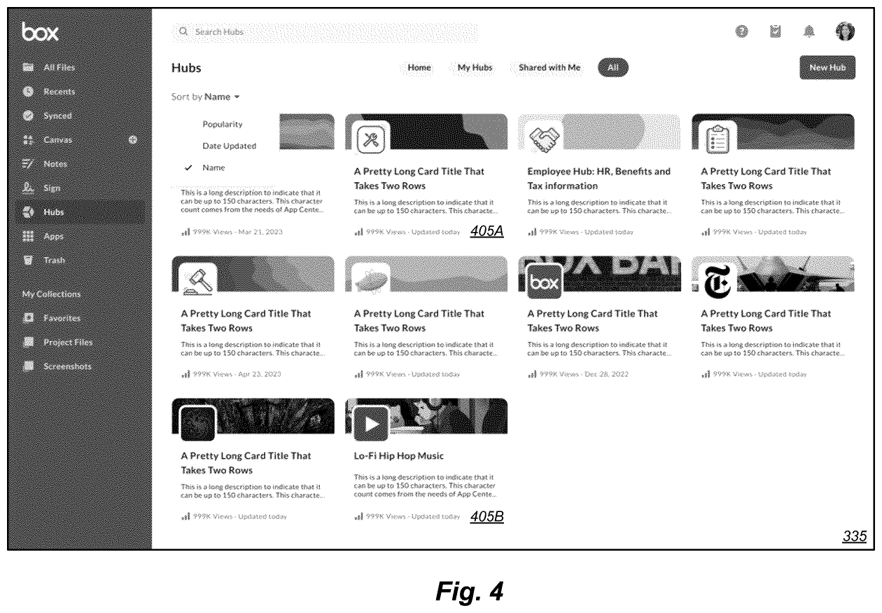

Also coupled with the communication network 310 can be any number of client devices 315A and 315B. The client devices 315A and 315B can comprise one or more personal computers, laptop computers, tablets, smartphones, and/or other computing devices as described above. Generally speaking, the client devices 315A and 315B can access services 320 of the collaboration system 305 via the communications network 320. Services 320 of the collaboration system 305, as will be described in greater detail below, provide for the storage of and access to content such as files and/or folders 325 in a repository 330. To facilitate access to and interaction with the services 320, the collaboration system 305 can provide a user interface 335. The user interface 335 can comprise any graphical, textual, or combination thereof interface including, but not limited to, one or more webpages to be rendered on the client devices 315A and 315B. An example of one such user interface 335 will be described below with reference to FIG. 4.

According to one embodiment, one or more services 320 of the collaboration system 305 can define, based on input from one or more client devices 315A and 315B, one or more CAOs 340. Generally speaking, each CAO 340 can comprise an abstraction of a collection of content items, i.e., files and/or folders 325, web links, etc., associated with the CAO and available to share collectively with users. As will be described, each CAO 340 can be represented in the user interface 335 as a collection of content accessible by users of the client devices 315A and 315B.

The content items collected in each CAO 340 can be represented therein by an associated Access Only Collaboration (AOC). Generally speaking, each AOC 345 can comprise a data structure defining access to content items in the associated CAO, e.g., an individual file, folder, web link, etc. In addition to access to the associated content item, each AOC may define, for example, notifications to be provided to users upon access or other event related to the associated content item based on user interactions with the content item through the user interface 335 rendered on client devices 315A and 315B.

FIG. 4 is a screenshot illustrating an exemplary user interface for a cloud-based collaboration environment according to one embodiment of the present disclosure. As illustrated in this example, the user interface 335 can comprise a grid of tiles 405A and 405B with each tile 405A and 405B representing individual content hubs. Each content hub can comprise a logical collection of content items including, but not limited to, files of various types, folders, web links, etc. The content hubs presented in the user interface for a given user can be those content hubs to which a collaboration has been added for that user. For any of the presented content hubs, the user can click or otherwise select a particular content hub to access the content items therein on an access only basis.

It should be noted that the user interface 335 presented in FIG. 4 and described here is offer by way of example for illustrative purposes only and is not intended to limit the scope of the present disclosure. Rather, it should be understood that the graphical and/or textual content as well as the format thereof can vary significantly depending upon the exact implementation without departing from the scope of the present disclosure. Rather, such various are contemplated and considered to be within the scope of the present disclosure.

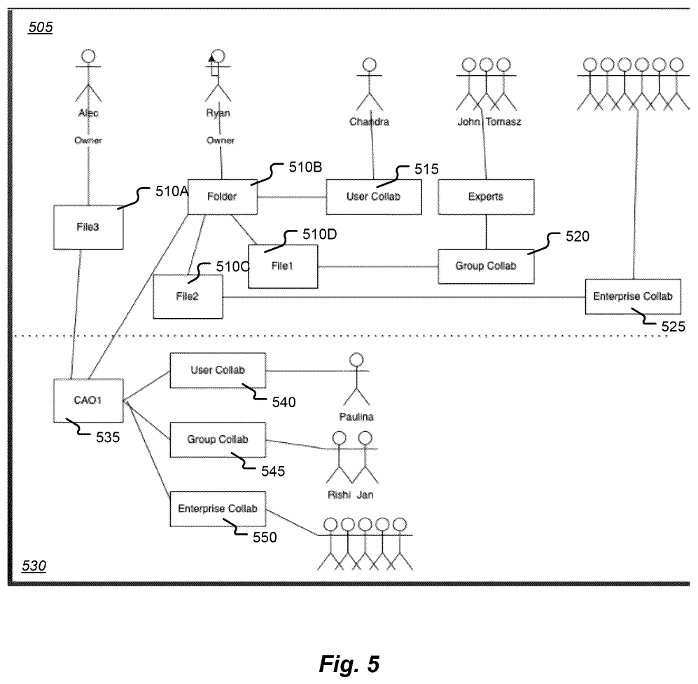

FIG. 5 is a block diagram conceptually illustrating sharing of content items in a cloud-based collaboration environment according to one embodiment of the present disclosure. More specifically, this example illustrates existing collaborations 505 as is typically defined. In this example, a set of content items 510A-510D are available in the collaboration system and shared by a number of users. The content items can be shared in different collaborations, e.g., through shared workspaces, etc. as known in the art. For example, a folder content item 510B can be shared between an owner and another user in a user collaboration. Other content items such as one or more file content items 510D can be shared between the owner and a number of other user in a group collaboration 520. Still other content items 510C can be shared in an enterprise collaboration 525 with all members of a business or other organization. In each case, the members of each collaboration access the content items therein according to individual permissions.

This example also illustrates a set of collaborations 530 based on a content hub defined by a CAO 535. As noted, the CAO 535 can identify and link to stored content items 510A and 510B. Regardless of other existing collaborations 505, other collaborations can be defined for the content items in the content hub based on a set of AOCs for that content hub. For example, AOCs for the content hub and associated with the CAO 535 can define a user collaboration 540 between the content item owner and another user, a group collaboration 545 between the content item owner and a set of users in a defined group, and an enterprise collaboration 550 between the content item owner and all members of a business or other organization. It should be noted that the membership, i.e., users, in the existing collaborations 505 and the membership in the content hub based collaborations 530 can be different, in whole or in part. Additionally, other than the owners of the content items and predefined editors thereof, i.e., users who have been granted permission to edit a content item within the content hub, users in the content hub based collaborations have access only permission, i.e., the content item is available for access within the content hub but implying interest from the users to which it is available.

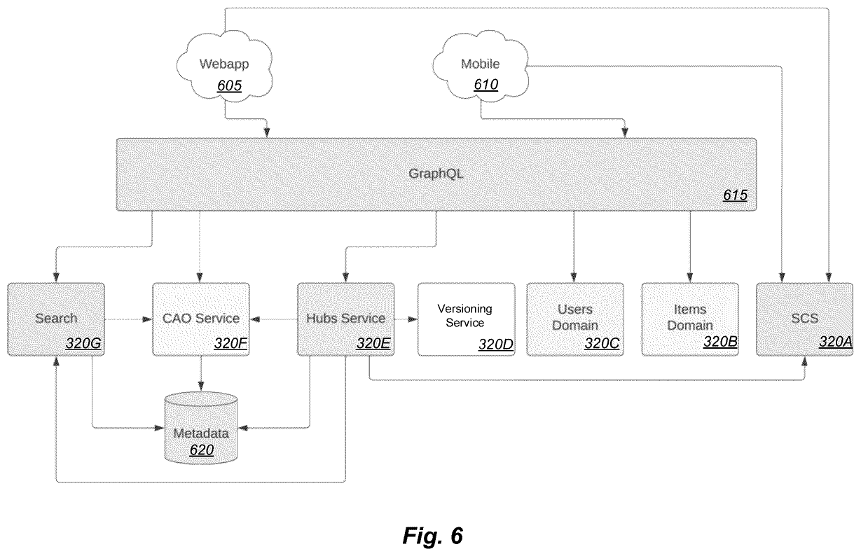

FIG. 6 is a block diagram illustrating additional details of a cloud-based collaboration system architecture according to one embodiment of the present disclosure. As illustrated in this example, users of a web-based client application 605 and/or a mobile application 610 can access services 320A-320G of the collaboration server 305 through an interface 615 such as an Application Program Interface (API). The various services 320A-320G can include, but are not limited to, a storage service 320A, an items domain service 320B, a users domain service 320C, a versioning service 320D, a hubs service 320E, a CAO service 32oF and a search service 320G.

Storage service 320A, is a service that allows users and/or applications to store and retrieve objects as an association to an entity, e.g., enterprise, user, etc. Storage service 320A allows generation of signed URLs that can be used directly from front-end, e.g., a client application, to upload and access the image files.

Versioning service 320D, can store versions of content. The content can be, for example, any string in json format. The hubs service 320E can leverage the versioning service 320D, for example, to store a layout document for each content hub and manage its versions whenever the content hub layout is updated.

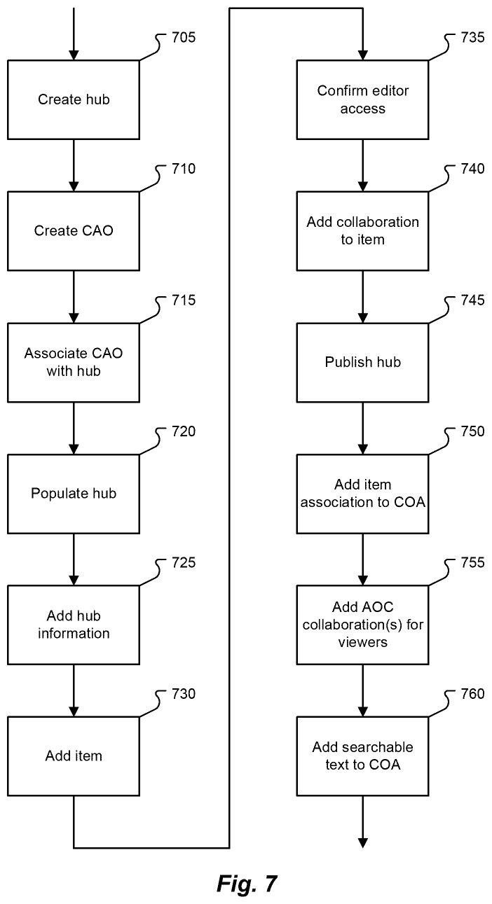

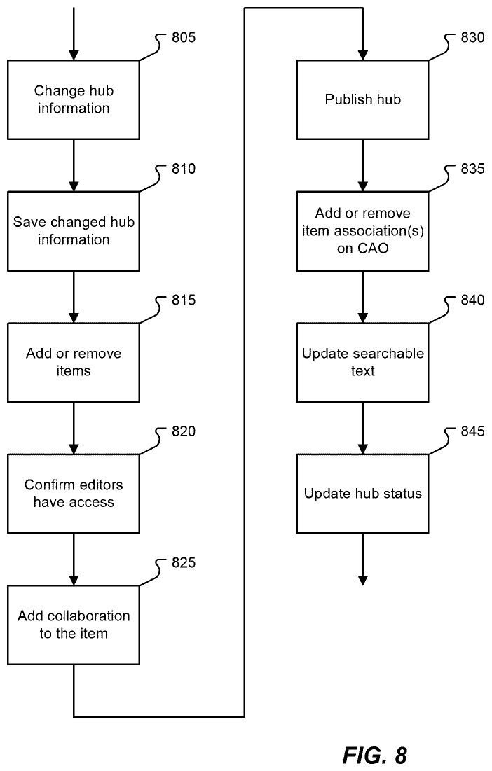

Hubs service 320E, as suggested above, can define, based on user input received from a web application 605 or mobile application 610, content hubs. CAO service 320F, together with the hubs services 320E can further define the CAO for a content hub, add content items to the content hub, define AOCs for collaborations, etc. Additional details of exemplary processes for creating and updating content hubs as may be performed by hubs service 320E and CAO service 320F are described further below with reference to FIGS. 7 and 8.

Search service 320G is a back-end service that indexes data from various sources and provides APIs to search for content based on the indexes. In the case of content hubs, the search service 320G can index some metadata 620 instance fields. Search service 320G can also provide an ability to query for various content hubs. This can be used to power a user interface 335 search/filter/sort. Search services 320G can also extend current file search services to be able to search for content files and folders associated to a content hub.

A metadata repository 620 or data store allows developers and services to create templates that can be attached to files, folders or content items. Then any objects of those types can have instances of those templates. The metadata repository 315 can provide APIs to query those metadata template fields to discover objects. The collaboration server 305 can create a content hub metadata template that can include fields that are used for data persistence and discovery. This metadata template can be CAO parented. Each content hub can then have a metadata instance that can store values for each of the hub template fields.

FIG. 7 is a flowchart illustrating an exemplary process for curating access-only content items of user groups in a cloud-based collaboration environment according to one embodiment of the present disclosure. More specifically, this example illustrates an exemplary process for creating a new content hub. As illustrated in this example, curating access-only content items of user groups in a cloud-based collaboration environment can comprise creating 705 a content hub in the cloud-based collaboration environment, the content hub comprising a logical representation of a collection of content items stored in a repository 330 maintained by a collaboration server 305. Creating the content hub in the cloud-based collaboration environment can further comprise creating 710 a Content Application Object (CAO) for the content hub and associating 715 the created CAO with the content hub.

The content hub can then be populated 720 with hub information defining the content hub. Populating the content hub can comprise adding 725 the hub information to the CAO, the hub information comprising one or more of a name for the content hub, a description of the content hub, or one or more sections within the content hub.

One or more selected content items of the content items stored in the repository 330 maintained by the collaboration server 305 can then be added 730 to the content hub. Adding one or more content items to the content hub can further comprise confirming 735 each editor of the added one or more content items has access to the one or more content items within the content hub, granting access to editors if needed, and adding 740 an AOC to the added one or more content items.

The content hub can then be published 745 in the cloud-based collaboration environment, wherein the selected content items added to the content hub are available for access only to one or more users of the collaboration server. Publishing the content hub in the cloud-based collaboration environment can further comprise adding 750 an association of each of the added one or more content items to the CAO, adding 755 an AOC collaboration for each of one or more viewers of the added one or more content items, and adding 755 searchable text to the CAO. The searchable text can describe the content hub or content items added to the content hub.

FIG. 8 is a flowchart illustrating an exemplary process for curating access-only content items of user groups in a cloud-based collaboration environment according to another embodiment of the present disclosure. More specifically, this example illustrates an exemplary process for creating a new content hub. As illustrated in this example, updating the content hub can comprise, for example, changing 805 the hub information, e.g., the name, descriptor, etc., In such cases, changing the hub information for the content hub can further comprise saving 810 the changed hub information for the content hub.

Additionally, or alternatively, updating the content hub can comprise adding and/or removing 815 one or more content items to or from the content hub. Adding one or more content items to the content hub can comprise further comprise confirming 820 editors for the added one or more content items have access to the added content items within the content hub, granting access to editors if needed, and adding 825 an AOC to the added content items.

The content hub can then be published 830 with the changed hub information, without the removed one or more content items or with the added one or more content items. Publishing the content hub can further comprise adding 835 content item associations on the CAO associated with the content hub for any added content items, removing 840 content item associations on the CAO associated with the content hub for any removed content items, updating 845 searchable text for the content hub, and updating 850 a status for the content hub, e.g., mark the CAO as updated.

The present disclosure, in various aspects, embodiments, and/or configurations, includes components, methods, processes, systems, and/or apparatus substantially as depicted and described herein, including various aspects, embodiments, configurations embodiments, sub-combinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving case and/or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A method for curating access-only content items of user groups in a cloud-based collaboration environment, the method comprising:
creating, by a processor of a collaboration server, a content hub in the cloud-based collaboration environment, the content hub comprising a logical representation of a collection of content items stored in a repository maintained by the collaboration server;
populating, by the processor of the collaboration server, the content hub with hub information defining the content hub;
adding, by the processor of the collaboration server, one or more selected content items of the content items stored in the repository maintained by the collaboration server to the content hub; and
publishing, by the processor of the collaboration server, the content hub in the cloud-based collaboration environment, wherein the selected content items added to the content hub are available for access only to one or more users of the collaboration server.

2. The method of claim 1, wherein creating the content hub in the cloud-based collaboration environment comprises:
creating a Content Application Object (CAO) for the content hub; and
associating the created CAO with the content hub.

3. The method of claim 2, wherein populating the content hub comprises adding the hub information to the CAO, the hub information comprising one or more of a name for the content hub, a description of the content hub, or one or more sections within the content hub.

4. The method of claim 2, wherein adding one or more content items to the content hub comprises:
confirming each editor of the added one or more content items has access to the one or more content items within the content hub; and
adding an Access Only Collaboration (AOC) to the added one or more content items.

5. The method of claim 4, wherein publishing the content hub in the cloud-based collaboration environment comprises:
adding an association of each of the added one or more content items to the CAO;
adding an AOC collaboration for each of one or more viewers of the added one or more content items; and
adding searchable text to the CAO, the searchable text describing the content hub or content items added to the content hub.

6. The method of claim 2, further comprising updating the content hub, wherein updating the content hub comprises:
one or more of changing the hub information for the content hub adding one or more content items to the content hub, or removing one or more content items from the content hub; and
publishing the content hub with the changed hub information, without the removed one or more content items or with the added one or more content items.

7. The method of claim 6, wherein changing the hub information for the content hub comprises saving the changed hub information for the content hub.

8. The method of claim 6, wherein adding one or more content items to the content hub comprises:
confirming editors for the added one or more content items have access to the added content items within the content hub; and
adding an Access Only Collaboration (AOC) to the added content items.

9. The method of claim 6, wherein publishing the content hub comprises:
adding content item associations on the CAO associated with the content hub for any added content items;
removing content item associations on the CAO associated with the content hub for any removed content items;
updating searchable text for the content hub; and
updating a status for the content hub.

10. A system comprising:
a processor; and
a memory coupled with and readable by the processor and storing therein a set of instructions which, when executed by the processor, causes the processor to curate access-only content items of user groups in a cloud-based collaboration environment by:
creating a content hub in the cloud-based collaboration environment, the content hub comprising a logical representation of a collection of content items stored in a repository maintained by the collaboration server;
populating the content hub with hub information defining the content hub;
adding one or more selected content items of the content items stored in the repository maintained by the collaboration server to the content hub; and
publishing the content hub in the cloud-based collaboration environment, wherein the selected content items added to the content hub are available for access only to one or more users of the collaboration server.

11. The system of claim 10, wherein creating the content hub in the cloud-based collaboration environment comprises:
creating a Content Application Object (CAO) for the content hub; and
associating the created CAO with the content hub.

12. The system of claim 11, wherein populating the content hub comprises adding the hub information to the CAO, the hub information comprising one or more of a name for the content hub, a description of the content hub, or one or more sections within the content hub.

13. The system of claim 11, wherein adding one or more content items to the content hub comprises:
confirming each editor of the added one or more content items has access to the one or more content items within the content hub; and
adding an Access Only Collaboration (AOC) to the added one or more content items.

14. The system of claim 13, wherein publishing the content hub in the cloud-based collaboration environment comprises:
adding an association of each of the added one or more content items to the CAO;
adding an AOC collaboration for each of one or more viewers of the added one or more content items; and
adding searchable text to the CAO, the searchable text describing the content hub or content items added to the content hub.

15. The system of claim 10, wherein the instructions further cause the processor to update the content hub, wherein updating the content hub comprises:
one or more of changing the hub information for the content hub adding one or more content items to the content hub, or removing one or more content items from the content hub; and
publishing the content hub with the changed hub information, without the removed one or more content items or with the added one or more content items.

16. The system of claim 15, wherein changing the hub information for the content hub comprises saving the changed hub information for the content hub.

17. The system of claim 15, wherein adding one or more content items to the content hub comprises:
confirming editors for the added one or more content items have access to the added content items within the content hub; and
adding an Access Only Collaboration (AOC) to the added content items.

18. The system of claim 15, wherein publishing the content hub comprises:
adding content item associations on the CAO associated with the content hub for any added content items;
removing content item associations on the CAO associated with the content hub for any removed content items;
updating searchable text for the content hub; and
updating a status for the content hub.

19. A non-transitory, computer-readable medium comprising a set of instructions stored therein which, when executed by a processor, causes the processor to curate access-only content items of user groups in a cloud-based collaboration environment by:
creating a content hub in the cloud-based collaboration environment, the content hub comprising a logical representation of a collection of content items stored in a repository maintained by the collaboration server, wherein creating the content hub in the cloud-based collaboration environment comprises creating a Content Application Object (CAO) for the content hub and associating the created CAO with the content hub;
populating the content hub with hub information defining the content hub, wherein populating the content hub comprises adding the hub information to the CAO, the hub information comprising one or more of a name for the content hub, a description of the content hub, or one or more sections within the content hub;
adding one or more selected content items of the content items stored in the repository maintained by the collaboration server to the content hub, wherein adding one or more content items to the content hub comprises confirming each editor of the added one or more content items has access to the one or more content items within the content hub and adding an Access Only Collaboration (AOC) to the added one or more content items; and
publishing the content hub in the cloud-based collaboration environment, wherein the selected content items added to the content hub are available for access only to one or more users of the collaboration server, wherein publishing the content hub in the cloud-based collaboration environment comprises adding an association of each of the added one or more content items to the CAO, adding an AOC collaboration for each of one or more viewers of the added one or more content items, and adding searchable text to the CAO, the searchable text describing the content hub or content items added to the content hub.

20. The non-transitory, computer-readable medium of claim 19, wherein the instructions further cause the processor to update the content hub, wherein updating the content hub comprises:
one or more of changing the hub information for the content hub adding one or more content items to the content hub, or removing one or more content items from the content hub, wherein changing the hub information for the content hub comprises saving the changed hub information for the content hub, wherein adding one or more content items to the content hub comprises confirming editors for the added one or more content items have access to the added content items within the content hub, and adding an Access Only Collaboration (AOC) to the added content items; and
publishing the content hub with the changed hub information, without the removed one or more content items or with the added one or more content items, wherein publishing the content hub comprises adding content item associations on the CAO associated with the content hub for any added content items, removing content item associations on the CAO associated with the content hub for any removed content items, updating searchable text for the content hub, and updating a status for the content hub.
